(19) United States
(12) Patent Application Publication
(10) Pub. No.: US 2017/0316408 A1
(43) Pub. Date: Nov. 2, 2017

(54) Bionumerical Authentication Systems

(71) Applicant: Oakley Kambel, Glen Head, NY (US)

(72) Inventor: Jacob Robert Bernesby, Glen Head, NY (US)

(21) Appl. No.: 15/143,966

(22) Filed: May 2, 2016

(51) Int. Cl. G06Q 20/38; H04L 29/06; G06Q 20/40; G06Q 20/10; H04L 9/14; H04L 9/30

(52) U.S. Cl. CPC G06Q 20/3829; H04L 63/0869; H04L 63/06; H04L 9/30; G06Q 20/1085; H04L 9/14; G06Q 20/40145; G06Q 2220/00

(57) ABSTRACT

A system is disclosed that adds a layer of security to a user who wishes to access an account. The system requires the user to enter both a private PIN number and biometric data (e.g. a fingerprint, an eye scan) into a device, which will then combine the data to create a new, secure PIN. The new PIN is then used to access the account. The new PIN could also be generated using ancillary data, such as the time of the request, a request PIN sent to the device from a server, or a GPS location of the device. In other embodiments, the device itself could transmit the new PIN instead of requiring the new PIN to be entered via the user.

### FIELD OF THE INVENTION

The field of the invention is unbanking security systems.

### BACKGROUND

The background description includes information that may be useful in understanding the present invention. It is not an admission that any of the information provided herein is prior art or relevant to the presently claimed invention, or that any publication specifically or implicitly referenced is prior art.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The prevalence of electronic identity theft increases the importance of securely making financial transactions. The theft of a PIN number or password can allow a criminal to clean out a bank account. Systems with improved security authentication procedures beyond a simple PIN number of password increase the security of transactions with a banking institution.

U.S. Pat. No. 8,752,145 to Dotan teaches a system that requires a mobile device to be authenticated with a photograph of the user. When the user takes a photograph of himself, the mobile device transmits the photograph to a picture match server and matches the picture using extracted facial geometry. If a match is found, the picture match server sends a PIN to the mobile device, which could be then used to allow the user to access a VPN application. A user of Dotan's system, however, could be easily spoofed using any photograph of the user's face.

U.S. Pat. No. 8,752,146 to van Dijk teaches a system that uses soft tokens to access an online banking site. Van Dijk's system collects biometric information, such as an image of the user's face and combines it with a token code to create an authentication code. The authentication code is then sent to the authentication server, which allows the user to access a resource server if the authentication code passes. Van Dijk's system, however, creates the token code.

U.S. Pat. No. 9,177,314 to Uzo teaches a system that allows a consumer to enter both his PIN and a fingerprint at a merchant's point of sale device. The combination of an instrument identification number (e.g. credit card number), digitized fingerprint data, and a PIN would be sent to an issuer's clearing server for authentication. The clearing server matches the fingerprint data against the IIN and PIN. Uzo's system, however, requires the fingerprint data to be sent electronically to the clearing server for each and every transaction, which might not always be safe on all networks.

Thus, there remains a need for a system and method that improves security of financial transactions.

### SUMMARY OF THE INVENTION

The following description includes information that may be useful in understanding the present invention. It is not an admission that any of the information provided herein is prior art or relevant to the presently claimed invention, or that any publication specifically or implicitly referenced is prior art.

The inventive subject matter provides apparatus, systems, and methods which require a user to pass an authentication protocol using a code and biometric data in order to gain access to an account. Such a system could be used to authenticate a user and generally requires a change that cannot be performed in the human mind by using a computer system to generate encrypted codes by combining an entered code with biometric data in accordance with one or more methods.

The system generally authenticates a user by requiring the user to input an encrypted code into the system, verifying the encrypted code, and then granting access to the user.

A handshake device is configured to generate the encrypted code that is seeded by two or more sets of data. Contemplated sets of data include a key associated with the user (e.g. a PIN, a UID, a password, a rolling code), a set of biometric data (e.g. a voiceprint identifier, a fingerprint, a facial image, a bodyprint, neurofeedback data), a time key (e.g. a time stamp, a time period, a clock), a geographic location (e.g. GPS coordinates, proximity to a terminal, key FOB indicator), and/or a code presented to the user via the terminal. The system could receive any of the data from the user through a plurality of means, for example through a user interface, for example a keyboard, touch screen, camera, microphone, fingerprint sensor, blood sampler, saliva sampler, neurofeedback device and/or could be received through modules that mine information. Contemplated handshake devices comprise PDAs, cellular phones, tablets, mobile devices, and other computer systems configured to accept data from one or more sources to generate the encrypted code. The handshake device could generate the encrypted code using any combination of two or more sets of contemplated data.

Once the handshake device generates the encrypted code, the encrypted code could then be provided to a terminal that is configured to accept the encrypted code. In some embodiments, the handshake device could transmit the encrypted code to the terminal directly, for example through a wired (e.g. serial port, Ethernet® port) or wireless connection (e.g. Bluetooth, Wifi, displaying a bar code to a screen), while in other embodiments the handshake device is configured to transmit the encrypted code to the user via a user interface, and the terminal is configured to then accept the encrypted code from the user interface. The terminal then transmits the encrypted code to a server, which then authenticates the encrypted code for the terminal. If the server deems the encrypted code to be authenticated, the server then transmits an authentication message to the terminal in order to grant the user access to an account via the terminal.

Contemplated terminals include ATM terminals, grocery checkout terminals, computer system terminals, and gaming terminals. Any terminal that requires a personalized user authentication to access features of a computer system could be configured to use the inventive systems described herein. The terminal could also be configured to accept a user identifier from the user, such as a UID (Unique Identifier), a unique PIN number, a biometric identifier, or an ID card (e.g. a driver's license, a passport, a credit card, an ATM card, a library card).

The server generally verifies the encrypted code by decrypting the encrypted code into a decrypted code, and compares the decrypted code against user information from a user database that is polled using the inputted user identifier. The server could be configured to use user information saved within its database to decrypt the encrypted code, such as a set of biometric data associated with the user, the user's location, or the user's PIN number. The server could access a database that holds such user data by searching for the user using a code inputted by the user into the terminal (e.g. the user's PIN number, a UID of the user, a location of the user).

In some embodiments, the server could be configured to accept one of the codes inputted by the user into the terminal (e.g. the user's PIN number, a UID of the user) and compare the received code against the decrypted code. In other embodiments, the server could be configured to use a unique identifier of the user to retrieve a set of personalized data specific to the user (e.g. biometric data, such as a fingerprint or facial features) associated with the user from a database, then decrypt the received encrypted code using the set of personalized data. In an alternative embodiment, the server could also accept an input code used to generate the encrypted code from the user via the terminal, decrypt the encrypted code using the set of personalized data, and then compare the decrypted code against the input code to determine whether the encrypted code was properly encrypted. In other embodiments, the server could provide one or more sets of code to the terminal, or to the user via the terminal, which is then used as a seed along with biometric or other personalized data to generate the encrypted code, which is then sent back to the server for verification.

Whatever the method, the server verifies the encrypted code as one that has been actually encrypted by the user using personalized information available only to the user (e.g. biometric information), and transmits an authentication message that grants the user access to an account via the terminal. The server could transmit the authentication message to the terminal itself, or to a computer system that the terminal is requesting access to. For example, the server could comprise a remote banking server that accepts the encrypted code and transmits an authentication message to the terminal, or the server could comprise a remote security server that accepts the encrypted code and transmits an authentication message to an access portal functionally coupled to the terminal, which then grants access to the user via the terminal.

Once the server transmits the authentication message, the system grants the user access to the user's account through the terminal. For example, where the terminal is a doorway, the system could open the door for the user. Where the system is an ATM machine, the terminal could provide the user access to an electronic bank account upon receipt of the authentication message, for example by dispensing cash specific to the user. Where the system is a gaming machine, the terminal could provide the user access to the user's gaming account.

Various objects, features, aspects and advantages of the inventive subject matter will become more apparent from the following detailed description of preferred embodiments, along with the accompanying drawing figures in which like numerals represent like components.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

### BRIEF DESCRIPTION OF THE DRAWING

FIG. 1 is an embodiment describing a computer system that authenticates a user via an encrypted code.

FIG. 2 is a flowchart that authenticates a user via an encrypted code.

### DETAILED DESCRIPTION

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be noted that any language directed to a computer system should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including providing a personalized layer of security that is difficult to counterfeit. A user who is given a debit card could provide some biometric data, and in order to access the debit card, the user could then insert the debit card into a transaction terminal and have biometric data collected from the user (e.g. a photograph, fingerprint, retina scan breath sample) in order to withdraw money from the debit account.

The present invention adds unconventional steps that confines the claim to a particular useful application by using biometric information to construct a single encrypted code along with personalized user data. Biometric information is difficult to counterfeit, but can be counterfeited with enough time and effort (e.g. lifting a fingerprint from a glass, taking a photograph of a user). Personalized user data is also difficult to counterfeit, but can also be counterfeited with enough time and effort (e.g. reading a PIN over a user's shoulder, guessing a password based upon user information, hacking an email). When such information is sent through a system, it could also be hacked by a dedicated backer (e.g. physically connecting to the network terminal). However, requiring an encrypted code that is generated using both pieces of information, where nether piece of personalized user information is directly contained within the code could provide a level of authentication which adds additional security and makes it much more difficult for an identity thief to counterfeit a user's identity.

The inventive subject matter provides apparatus, systems, and methods in which an inventive system authenticates a user.

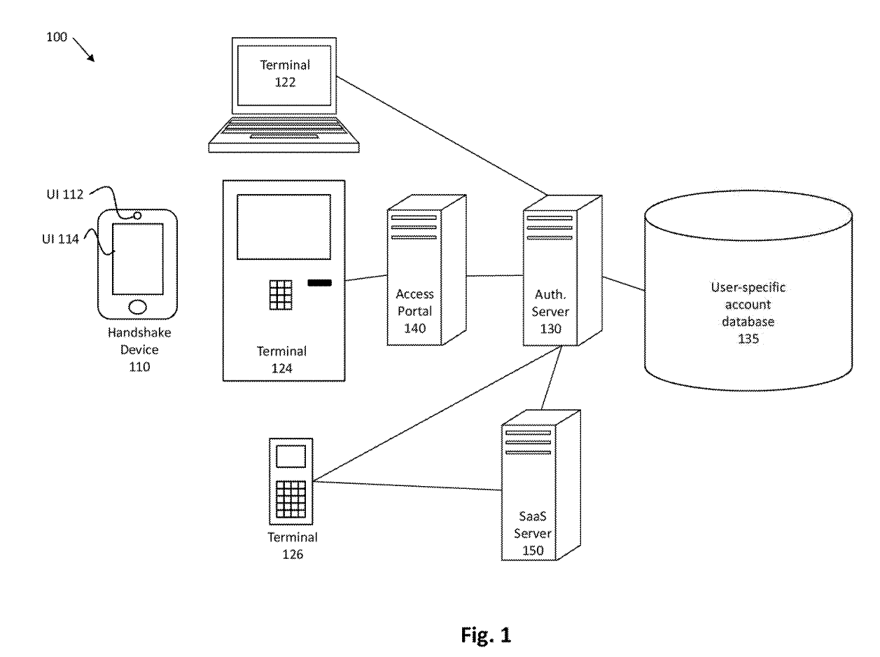

In FIG. 1, an exemplary system 100 has handshake device 110, terminals 122, 124, and 126, authentication server 130, database 135, access portal 140, SaaS server 150, and lock 160. Handshake device 110 is shown as a euphemistically as a mobile phone having at least two user interfaces, camera 112 and touchscreen 114. Handshake device 110 could be any computer system that is configured to accept a plurality of sets of data from a user to generate an encrypted code. For example, a user could input a user PIN and biometric information. While two user interfaces are shown to capture two different types of sets of data, a single user interface or three or more user interfaces could be used without departing from the scope of the invention. Handshake device 110 could be configured to communicate with authentication server 130, but does not need to communicate with authentication server 130 in order to satisfy all aspects of the invention. In some embodiments, handshake device 110 could be configured to not have any wired or wireless network connections to be a completely secure system that only accepts information from a user to generate encrypted codes. For example, handshake device could be a device that is absent any ports or wireless connections, and could be configured to be charged wirelessly, ensuring that handshake device 110 is completely informationally shielded and secure. In this manner, any user of handshake device 110 could be assured that any private information, such as biometric information, that is entered into handshake device 110 could not be stolen or compromised.

Terminal 122 is shown as a computer user interface with a keyboard and screen, terminal 124 is shown as an ATM machine having a keycard slot, a keypad, and a screen, and terminal 126 is shown as a door lock having a touchscreen, although other user interfaces having at least one input interface and at least one output interface could act as a terminal for a user of system 100 without departing from the scope of the invention. A user accesses any one of terminals 122, 124, or 126 to attempt to access some service through a network connection, such as an intranet or the Internet. While the network connections in FIG. 1 are represented as lines to various computer systems, terminals, and databases, contemplated networks could be wired or wireless, could be using one or many protocols to connect the devices, and/or could communicate through a LAN, intranet or the Internet without departing from the scope of the invention.

A user (not shown) who wishes to gain access to any of terminals 122, 124, and/or 126 needs to first obtain an encrypted code from handshake device 110. Typically, the user will enter at least a code into user interface 114 and biometric information into user interface 110. While user interface 114 is shown as a touch screen device, other user interfaces are contemplated, such as a card reader, a QR code reader, a keyboard, a keypad, and/or a microphone. While user interface 112 is shown as a camera, other user interfaces are contemplated, such as a microphone, fingerprint sensor, blood sampler, and/or saliva sampler. Handshake device 110 collects at least two sets of information from the user to generate the encrypted code, and could use other contextual data to generate the encrypted code as well, for example geographic location, a code provided by the terminal, terminal-specific information (e.g. a UID of the terminal, a QR code of the terminal, an RFID code of the terminal), and/or a time key. Once the encrypted code has been generated by handshake device 110, the user could enter the encrypted code into one of terminals 112, 124, and/or 126 to gain access to an account via the terminal.

Terminal 122 gains access to SaaS server 150 through authentication server 130. In this embodiment, authentication server 130 acts as a proxy to SaaS server 150, authenticating access when needed. A user is authenticated on terminal 122 by typing in a valid encryption code into the terminal 122. The encryption code is then sent to authentication server 130, which then decrypts the transmitted encryption code, at least in part, by using user-specific information saved on database 135. Database 135 could be saved on any non-transient computer-readable medium in any manner, such as a csv file, a DBMS (Database Management System) accessible by an ODBC (Open Database Connectivity) standard, or any other suitable medium. While Database 135 is shown as a NAS device functionally coupled to authentication server 130 via a network connection, Database 135 could be stored upon a family of computer devices, or could be saved upon an internal hard drive of authentication server 130 without departing from the scope of the invention.

Once the encryption code is verified, authentication server 130 could provide terminal 122 access to the user's account on SaaS server 150. In some embodiments, terminal 122 or authentication server 130 could be configured to re-authenticate the user periodically by requesting a new encryption code. Terminal 122 is shown as a computer terminal that accesses its account on authentication server 130, which could be through a proprietary client or through a generic client, such as a web browser. While terminal 122 is shown as a computer terminal, other terminals could be used with a similar system architecture without departing from the scope of the current invention.

Terminal 124 gains access to access portal 140 directly. Terminal 124 is shown as an ATM that request's a user's account information via a bank card with an electronically encoded unique identifier that is tied to a user or to a specific bank account. When terminal 124 requests access to a user's account information on access portal 140, Access portal 140 requests authentication server 130 to execute an authentication process. Authentication server 130 could then serve up an applet in a GUI of access portal 140, or could simply request access portal 140 to transmit the encrypted code to authentication server 130 for authentication. In either case, in terminal 124, the user receives a request for the encrypted code, and the user enters the encrypted code into terminal 124 using its user interface. The encrypted code is then transmitted to authentication server 130, which then authenticates whether or not the encrypted code is at least properly encrypted with biometric user information. If authentication server 130 is able to properly authenticate the user, authentication server 130 transmits an authentication message to access portal 140, which then allows the user access to his account via terminal 124. Terminal 124 is shown as an ATM terminal that accesses a user's bank account via access portal 140, which could then allow the user to deposit or withdraw money as needed. In some embodiments, access portal 140 could be configured to re-authenticate the user periodically by requesting a new encryption code. While terminal 124 is shown as an ATM terminal, other terminals could be used with a similar system architecture without departing from the scope of the current invention.

Terminal 126 communicates directly with both authentication server 130 and SaaS server 150. Terminal 126 is shown as a screen and a keypad that could be used to gain access to SaaS server 150. In the present embodiment, SaaS server 150 controls access to an entryway that the user wishes to gain access to, but could provide cloud-based services similar to the services provided to terminal 122. Terminal 126 receives an encrypted code from the user and transmits that code to authentication server 130 for authentication. If the user's encrypted code is encrypted to a user account that has access to the service (in this case an entryway), authentication server 130 could then transmit an authentication message to SaaS server 150, which then provides the service directly to terminal 126 (in this case, the ability to open or lock an entryway). While terminal 126 is shown as a simplistic locking terminal, other terminals could be used with a similar system architecture without departing from the scope of the current invention.

While system 100 shows handshake device 110 as a separate computer system from terminals 122, 126, and 126, in some embodiments the functionality of the handshake device and the terminal could be within the same computer system. For example a terminal (not shown) could both ask for a code and biometric information from a user, communicate with authentication server 130, and receive authentication without departing from the scope of the invention.

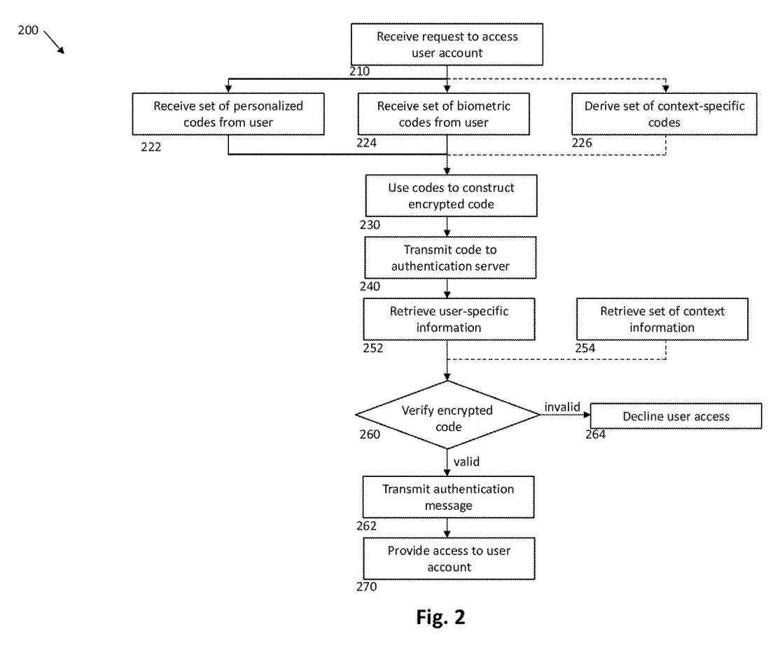

In FIG. 2, a flowchart 200 shows a method of the invention to authenticate a user. In step 210, the system receives a request to access the user account. Typically, the request is received by a terminal that is accessed via the terminal. The request to access the user account could include an identifier of the user, for example an account number, a, alphanumeric UID, or some other identifier that identifiers a user or a class of users. In step 212, the handshake device receives a set of personalized codes from the user. Such personalized codes could include, for example, a PIN number, a password, a rotating code, a captured gesture of the user, or a captured movement of the user. At least one personalized code is generally received by the handshake device, although other codes could be provided without departing from the scope of the current invention. In step 214, the handshake device also receives a set of biometric codes from the user. Such biometric codes could include, for example, a photograph of the user's face, a fingerprint, a blood sample, or a saliva sample. At least one biometric code is generally received by the handshake device. In optional step 226, the handshake device could also derive a set of context-specific codes. Such codes could include, for example, a geographic location of the handshake device, a time stamp, a version of software, or a MAC address.

In step 230, the handshake device uses at least two of the codes to construct the encrypted code. The encrypted code is generated using at least one personalized code and one biometric code from the user. The encrypted code could be encrypted using the received codes in any manner, for example the encrypted code could encrypt the personalized code using the biometric code as a hash key or vice versa, or the handshake device could merely encrypt the received codes within a package that is then transmitted to the authentication server.

In step 240, the encrypted code is transmitted to the authentication server. In some embodiments, the encrypted code is simply shown to the user, who then inputs the encrypted code into a user interface of the terminal, which then transmits the encrypted code to the authentication server. In other embodiments, the handshake device could be paired with the terminal (e.g. via a port or a wireless connection), which then transmits the encrypted code through the electronic connection. Contextual user information is also typically sent with the encrypted code, for example a user identifier, an account identifier, a terminal identifier, a MAC address, and/or other contextual information which the authentication server could use to identify which user account is purportedly requesting access to which terminal.

In step 252, the authentication server retrieves user-specific information that will be used to verify whether the encrypted code contains the correct user information. Contemplated user-specific information includes a UID (e.g. a username or a bank card number), an account identifier, a PIN, a password, facial attributes, fingerprint attributes, blood attributes, saliva attributes, user preferences, user account information, group account information, and rights information. Optionally, the authentication server could also retrieve context information, such as whether the terminal is located, a time stamp, and/or a log of terminal inputs.

In step 260, the authentication server then verifies the encrypted code using the retrieved information to determine if the user has constructed the encrypted code using the correct biometric information (and possibly contextual information). In some embodiments, the authentication server might decrypt the encrypted code using a first set of user data, and then compares the decrypted code against a second set of user data, but preferably the authentication server generates an encrypted code of its own using the user data available and compares the two codes with one another. If the user has not constructed the encrypted code using the correct information, the authentication server detects that the encrypted code is invalid and declines the user access in step 264. If the user has constructed the encrypted code using the correct information, the authentication server transmits an authentication message in step 262 (e.g. to the terminal, to a SaaS server, or to another module of the authentication server), and provides access to the user account in step 270.

In some embodiments, a user could be provided with access to an account, and could then be asked to submit a user PIN, biometric information, and possibly some contextual data (e.g. when will the user access the account, which terminal(s) will the user use to access the account). That information is then sent to a database, such as database 135 for access by an authentication server. When the user wishes to access the account, the user merely needs to generate an encrypted code using a handshake device (e.g. a cellphone) by inputting the appropriate personalized code and biometric code into the handshake device, and use that encrypted code to access the account.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for authenticating a user, comprising:
a first user interface configured to accept a first code from a user;
a second user interface configured to accept a first set of biometric data from the user;
a handshake device configured to generate an encrypted code as a function of the first code and the first set of biometric data;
a terminal configured to accept the encrypted code; and
a server configured to verify the encrypted code and transmits an authentication message to grant the user access to an account via the terminal.

2. The system of claim 1, wherein the terminal is also configured to accept the first code from the user, and wherein the server is further configured to verify the encrypted code by decrypting the encrypted code into a decrypted code and comparing the decrypted code against the first code.

3. The system of claim 2, wherein the server is further configured to:
retrieve a second set of biometric data associated with the user from a database; and
decrypt the encrypted code as a function of the second set of biometric data.

4. The system of claim 3, wherein the server is further configured to retrieve the second set of biometric data as a function of the accepted first code.

5. The system of claim 1, wherein the terminal is configured to accept a unique identifier of the user, and wherein the server is configured to verify the encrypted code as a function of the unique identifier.

6. The system of claim 5, wherein the server is also configured to accept the first code from the user, and wherein the server is further configured to verify the encrypted code by decrypting the encrypted code into a decrypted code and comparing the decrypted code against the first code.

7. The system of claim 6, wherein the server is further configured to:
retrieve a second set of biometric data from a database as a function of the unique identifier of the user; and
decrypt the encrypted code as a function of the second set of biometric data.

8. The system of claim 1, wherein the first user interface comprises at least one of a keyboard, a mouse, and a touch screen.

9. The system of claim 1, wherein the second user interface comprises at least one of a camera, a fingerprint scanner, a blood sampler, and a saliva sampler.

10. The system of claim 1, wherein the handshake device comprises a mobile device.

11. The system of claim 1, wherein the terminal comprises an ATM machine.

12. The system of claim 11, wherein the terminal is configured to provide access to an electronic bank account upon receipt of the authentication message.

13. The system of claim 1, wherein the server comprises a remote banking server, and wherein the terminal is further configured to transmit the encrypted code to the remote banking server.

14. The system of claim 13, wherein the server is further configured to transmit the authentication message to the terminal.

15. The system of claim 1, further comprising a third user interface configured to accept a second code from the user, wherein the handshake device is configured to generate the encrypted code as a function of the first code, the second code, and the first set of biometric data.

16. The system of claim 15, wherein the terminal is configured to present the second code to the user.

17. The system of claim 16, wherein the server is configured to provide the second code to the terminal in response to a request, via the terminal, to access the account.

18. The system of claim 1, wherein the handshake device is further configured to receive a second code from a clock, and wherein the handshake device is further configured to generate the encrypted code as a function of the first code, the first set of biometric data, and the second code.

19. The system of claim 1, wherein the handshake device is further configured to receive a second code from the server, and wherein the handshake device is further configured to generate the encrypted code as a function of the first code, the first set of biometric data, and the second code.

20. The system of claim 1, wherein the terminal is further configured to:
accept a request for cash as a function of the account; and
dispense cash to the user as a function of the request for cash.
